(19) United States
(12) Patent Application Publication
(10) Pub. No.: US 2005/0147083 A1
(43) Pub. Date: Jul. 7, 2005

(54) Method for determining whether a transaction is completed correctly and data transmission network

(75) Inventors: Peter Domschitz, Stuttgart (DE); Marco Tomsu, Ditzingen (DE); Marcus Kessler, Stuttgart (DE)

Correspondence Address: SUGHRUE MION, PLLC, 2100 PENNSYLVANIA AVENUE, N.W., SUITE 800, WASHINGTON, DC, 20037, US

(73) Assignee: ALCATEL

(21) Appl. No.: 10/989,093

(22) Filed: Nov. 16, 2004

(30) Foreign Application Priority Data
Jan. 5, 2004 (EP) 04360001.4

(51) Int. Cl. H04L 1/00

(52) U.S. Cl. 370/351

(57) ABSTRACT

This invention relates to a method comprising the steps of receiving content data from a first subscriber by a first network node, setting up a first data content report, comprising information about content data, or receiving said first data content report from said first subscriber, by said first network node, setting up said transmission path by choosing a second network node, having an exclusive data transfer connection to a second subscriber, by said network controlling means, sending said content data from said first network node to said second network node.

### BACKGROUND OF THE INVENTION

The invention is based on a priority application EP 04360001.4 which is hereby incorporated by reference.

This invention relates to a method for determining whether a transaction comprising a transmission of content data from a first subscriber to a second subscriber via network nodes of a data transmission network building a transmission path, said transmission network being controlled by controlling means of a network controller, is completed correctly and a data transmission network and a network node comprising means, being designed to carry out the method.

The method relates to an improved usage of, e.g. Gateways, Digital Subscriber Line Access Multipliers (DSLAM), Wireless/Mobile Access Nodes, Session Border Elements, Access Gates, novel service-creation platforms and/or related software.

The emerging broadband market for fixed, e.g. DSL, and/or mobile, e.g. GPRS and/or UMTS, networks is evolving towards a single Internet Protocol- (IP-) based converged universal multiservice delivery platform, offering a giant market volume for innumerable service providers.

Reliable and trusted content delivery tightly coupled with a micro-payment solution is considered as a key prerequisite for the global arise of E-commerce and commoditization of World Wide Web- (WWW-) based services. For telecommunication (telco) network operators, making money today with pure Internet connectivity service, the field of service creation support is an obvious opportunity for an extension of their business models.

There are several demands on a trusted content delivery method and/or system to enable the extension of these business models:
Customers and service providers both demand for a reliable delivery of pay-content, and payment solutions which satisfy convenience, commodity and security aspects as well.
The service provider needs confirmation, that the content has really been delivered to the ordering customer, equivalent to certified mail, i.e. proof-of-delivery (POD). This enables lawful reminding of the customers, because it is required for legally effective reminding of the customers. Also the payments should be guaranteed with successful delivery, equivalent to cash-on-delivery (COD).
The customer demands a trusted relationship to the service provider itself or a sales and billing proxy. As in traditional business relations the customers want to pay only after receiving the requested content. Also it is not in the interest of the customer to “broadcast” sensitive banking information like credit card numbers over the network to a increasing number of service providers with unknown and/or untrusted reputation.

According to prior art there are WWW-based solutions with service-individual login or authentication procedures, followed by an exchange of sensitive banking information, and a transport of the content data (content) via the internet.

The existing solutions offer neither security nor true convenience. These disadvantages are resulting in the following problems:
Inconvenience for the customer (subscriber);
Disclosure of customers sensitive banking information to any content provider;
False payment in case of service interruption and incomplete and/or corrupted delivery of content data;
Service misuse as hijacking of connections, address and/or username faking is possible;
No delivery confirmation for the content provider that the content has in fact been delivered to the authorized customer is provided.

It is therefore an object of the invention to provide a method for determining whether a transaction is completed correctly and a data transmission network and a network node for carrying out the method which overcome the problems associated with the related art, in particular which provide a reliable and trusted content delivery from a first to a second subscriber.

### SUMMARY OF THE INVENTION

The object concerning a method for determining whether a transaction is completed correctly is attained by the method for determining whether a transaction comprising a transmission of content data from a first subscriber to a second subscriber via network nodes of a data transmission network building a transmission path, said transmission network being controlled by controlling means of a network controller, is completed correctly, comprising the steps of
receiving said content data from said first subscriber by a first network node of said network nodes,
setting up a first data content report, comprising information about said content data, or receiving said first data content report from said first subscriber, by said first network node,
setting up said transmission path by choosing a second network node of said network nodes, having an exclusive data transfer connection to said second subscriber, by said network controlling means,
sending said content data from said first network node to said second network node,
setting up a second data content report, comprising information about said content data, by said second network node,
sending said content data from said second network node to said second subscriber,
making a comparison by comparing said first data content report to said second data content report, by said network controlling means and
deciding whether said transmission of content data from said first subscriber to said second subscriber is completed correctly depending on a result of said comparison, by said network controlling means.

The object concerning the network node is attained by a network node of a path of a data transmission network for carrying out the method for determining whether a transaction comprising a transmission of content data from a first subscriber to a second subscriber via said path is completed correctly the method for determining whether a transaction comprising a transmission of content data from a first subscriber to a second subscriber via network nodes of a data transmission network building a transmission path, said transmission network being controlled by controlling means of a network controller, is completed correctly, comprising the steps of
receiving said content data from said first subscriber by a first network node of said network nodes,
setting up a first data content report, comprising information about said content data, or receiving said first data content report from said first subscriber, by said first network node,
setting up said transmission path by choosing a second network node of said network nodes, having an exclusive data transfer connection to said second subscriber, by said network controlling means,
sending said content data from said first network node to said second network node,
setting up a second data content report, comprising information about said content data, by said second network node,
sending said content data from said second network node to said second subscriber,
making a comparison by comparing said first data content report to said second data content report, by said network controlling means and deciding whether said transmission of content data from said first subscriber to said second subscriber is completed correctly depending on a result of said comparison, by said network controlling means,
comprising
content data receiving means, being designed to receive said content data,
content reporting means, being designed to set up a first data content report, or to receive a first data content report, comprising information about said content data,
sending means, being designed to send said content data to said second subscriber or to a second network node,
data content report receiving means, being designed to receive a second data content report, comprising information about said content data,
network controlling means, being designed to make a comparison by comparing said first data content report to said second data content report and to decide whether said transmission of content data from said first subscriber to said second subscriber is completed correctly depending on a result of said comparison.

The object concerning the data transmission network is attained by a data transmission network for carrying out the method for determining whether a transaction comprising a transmission of content data from a first subscriber to a second subscriber via network nodes of a data transmission network building a transmission path, said transmission network being controlled by controlling means of a network controller, is completed correctly the method for determining whether a transaction comprising a transmission of content data from a first subscriber to a second subscriber via network nodes of a data transmission network building a transmission path, said transmission network being controlled by controlling means of a network controller, is completed correctly, comprising the steps of
receiving said content data from said first subscriber by a first network node of said network nodes,
setting up a first data content report, comprising information about said content data, or receiving said first data content report from said first subscriber, by said first network node,
setting up said transmission path by choosing a second network node of said network nodes, having an exclusive data transfer connection to said second subscriber, by said network controlling means,
sending said content data from said first network node to said second network node,
setting up a second data content report, comprising information about said content data, by said second network node,
sending said content data from said second network node to said second subscriber,
making a comparison by comparing said first data content report to said second data content report, by said network controlling means and
deciding whether said transmission of content data from said first subscriber to said second subscriber is completed correctly depending on a result of said comparison, by said network controlling means, comprising
a first network node of said network nodes, being designed to receive said content data from said first subscriber, and to set up a first data content report, comprising information about said content data, or receiving said first data content report from said first subscriber,
said controlling means being designed to set up said transmission path by choosing a second network node of said network nodes, having an exclusive data transfer connection to said second subscriber,
sending means, being designed to send said content data from said first network node to said second network node,
said second network node, being designed to set up a second data content report, comprising information about said content data and to send said content data from said second network node to said second subscriber, and
said controlling means being designed to make a comparison by comparing said first data content report to said second data content report, and to decide whether said transmission of content data from said first subscriber to said second subscriber is completed correctly depending on a result of said comparison.

Further advantageous features of the invention are defined in the depending claims.

The inventive method for determining whether a transaction comprising a transmission of content data from a first subscriber to a second subscriber via network nodes of a data transmission network building a transmission path, said transmission network being controlled by controlling means of a network controller, is completed correctly, is comprising the steps of:
receiving said content data from said first subscriber by a first network node of said network nodes,
setting up a first data content report, comprising information about said content data, or receiving said first data content report from said first subscriber, by said first network node,
setting up said transmission path by choosing a second network node of said network nodes, having an exclusive data transfer connection to said second subscriber, by said network controlling means,
sending said content data from said first network node to said second network node,
setting up a second data content report, comprising information about said content data, by said second network node,
sending said content data from said second network node to said second subscriber,
making a comparison by comparing said first data content report to said second data content report, by said network controlling means and deciding whether said transmission of content data from said first subscriber to said second subscriber is completed correctly depending on a result of said comparison, by said network controlling means.

A service using the inventive method is specially tailored to telcos, which operate as network access providers (NAP), because they have exclusive control over the network nodes (access node hardware) of the transmission network, i.e. the network controller is a NAP. In general the network controller can be associated with an institution, which provides a trusted content delivery service. It has the right to control the network nodes of the transmission path. The exclusive data transfer connection is an unambiguous physical relation from the second network node to the second subscriber, i.e. to a terminal used by the second subscriber. For example this relation is a telephone connection. If there is confidence between the first subscriber, e.g. a content provider, and the network controller the first data content report can be received from the first subscriber. The network controlling means can be part of one of the network nodes of the transmission part as well as they can be part of a further network node, i.e. any computer, being controlled by the network controller. In the latter case the data content reports have to be sent to the further network node to be compared.

The inventive method results at least in the following advantages:
The inventive method offers straightforward support of micropayment and payment-after-delivery mechanisms, e.g. by the monthly bill of the NAP.
No special requirements and extensions of customer (first subscriber) and content provider (second subscriber) equipment is needed.
Content providers can open up a large customer base for trusted content delivery and/or micropayment by a single contract with a large telco company.
To use the inventive method, only an upgrade of current best-effort internet towards quality and service-awareness is needed. This only includes programmable network elements near to the network access points to host the subscriber-related software to perform the steps of the inventive method (data flow objects). The basic functions, like policy enforcement points, are required for IP-based multi-service networks anyway.
The inventive method may be used by any telco supplier offering service-aware IP networks and any E-commerce infrastructure supplier. Trusted content delivery combined with micro-payment support will be requested from all telco operators to increase their business opportunities.

Preferably, a message comprising data characterising the content data to be transmitted is received by said first network node. This message enables the network controller to deliver contents being requested by one of the subscribers.

It is preferred that data comprising information characterising said transaction, preferably a transaction code, is sent from said first network node to said second network node or network controller, preferably said controlling means. Thus said transaction is specified unambiguously.

Very advantageously, a data flow software object is instantiated by said network controlling means in said first and said second network node. Said data flow software object is comprising software code sections by which the steps of the inventive method are carried out. By the aid of said data flow objects said content data is transmitted using a special transmission protocol and/or a specific encryption code. Thus only the data flow objects which are instantiated to perform a specific transaction can send and receive the content data concerning this transaction.

Preferably, said first and/or second data content report is comprising information characterising said transaction, preferably a transaction code received from said network controlling means by said first and/or said second network node. This enables a user of the inventive method to use the transaction code to encrypt the content data and/or the data content reports before transmitting them.

The inventive network node of a path of a data transmission network for carrying out the method for determining whether a transaction comprising a transmission of content data from a first subscriber to a second subscriber via said path is completed correctly according to the inventive method is comprising:
content data receiving means, being designed to receive said content data,
content reporting means, being designed to set up a first data content report, or to receive a first data content report, comprising information about said content data,
sending means, being designed to send said content data to said second subscriber or to a second network node,
data content report receiving means, being designed to receive a second data content report, comprising information about said content data,
network controlling means, being designed to make a comparison by comparing said first data content report to said second data content report and to decide whether said transmission of content data from said first subscriber to said second subscriber is completed correctly depending on a result of said comparison. The inventive network node is being designed to carry out the steps of the inventive method. Therefore it offers the possibility to achieve the advantages of the inventive method. As the inventive network node is part of the transmission path, no additional controlling means are necessary.

The inventive data transmission network for carrying out the inventive method for determining whether a transaction comprising a transmission of content data from a first subscriber to a second subscriber via network nodes of a data transmission network building a transmission path, said transmission network being controlled by controlling means of a network controller, is completed correctly, is comprising:
a first network node of said network nodes, being designed to receive said content data from said first subscriber, and to set up a first data content report, comprising information about said content data, or receiving said first data content report from said first subscriber,
said controlling means being designed to set up said transmission path by choosing a second network node of said network nodes, having an exclusive data transfer connection to said second subscriber,
sending means, being designed to send said content data from said first network node to said second network node,
said second network node, being designed to set up a second data content report, comprising information about said content data and to send said content data from said second network node to said second subscriber, and
said controlling means being designed to make a comparison by comparing said first data content report to said second data content report, and to decide whether said transmission of content data from said first subscriber to said second subscriber is completed correctly depending on a result of said comparison.

The inventive data transmission network is being designed to carry out the steps of the inventive method. Therefore it offers the possibility to achieve the advantages of the inventive method. If the controlling means of the transmission network are not part of the network nodes being part of the transmission path the steps of the inventive method can be controlled by means of a central controlling device, comprising the controlling means.

Preferably said first network node is having an exclusive data transfer connection to said first subscriber. If there is no confidence between the first subscriber and the network controller, this preferred embodiment enables trusted content delivery. If a network which is not controlled by the network controller is positioned between the first subscriber and the first network node, the latter one should be an access node to the network, which is controlled by the network controller to certify reasons of possible data losses occurring outside the network controlled by the network controller.

In another preferred embodiment of the invention, the data transmission network for carrying out the method for determining whether a transaction comprising a transmission of content data from a first subscriber to a second subscriber via said path is completed correctly according to the inventive method is comprising an inventive network node and at least a second network node, comprising content data receiving means, being designed to receive said content data, content reporting means, being designed to set up a data content report, or to receive a data content report, comprising information about said content data, and sending means, being designed to send said content data to said second subscriber or to a second network node. In this embodiment the inventive network node is used to carry out the inventive method. Therefore it offers the possibility to achieve the advantages of the inventive network node.

In another very preferred embodiment of the invention the inventive data transmission network is comprising at least one microcomputer loaded with a computer program with software code sections by which the steps of the inventive method are carried out. If the inventive method is carried out and/or controlled by a computer program, existing network nodes only have to be loaded with a software with software code sections by which the steps of the inventive method are carried out. No hardware adoption is necessary.

The different features of the preferred embodiments of the invention may be used in combination together with the invention as set forth in the independent claims or just each single preferred embodiment together with the invention as set forth in the independent claims.

### BRIEF DESCRIPTION OF THE DRAWINGS

The embodiments of the invention will now be described with reference to the accompanying drawings.

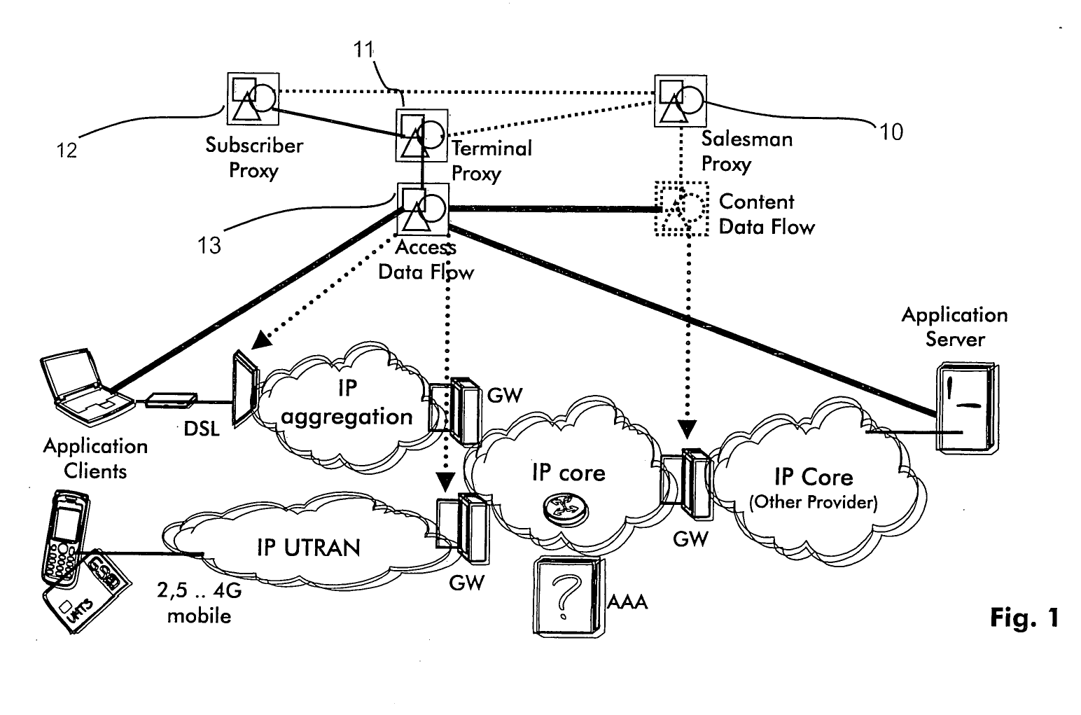

In FIG. 1 an example scenario in which the inventive method is used for a reliable delivery of content data in a trusted content delivery system, building a data transmission network according to the invention, is shown.

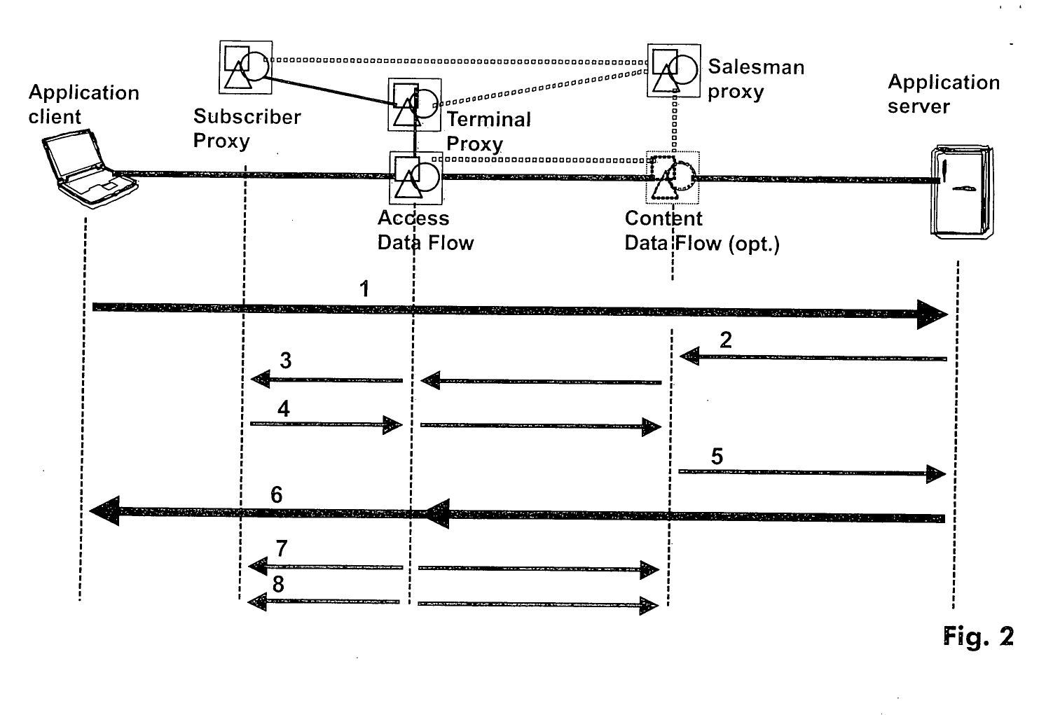

In FIG. 2 an example of the inventive method used to deliver content data from a content application server to a client application is shown.

### DETAILED DESCRIPTION OF THE DRAWINGS

The inventive data transmission network shown in FIG. 1 is comprising network nodes (gateways (GW)) and controlling means which are performing the steps of the inventive method concerning e.g. authentication, authorization and accounting (AAA). Content data is transmitted via a transmission path built of network nodes from a first subscriber (application server) to a second subscriber (application client), i.e. the content data is transmitted from a terminal, e.g. an application server of the first subscriber to a terminal, e.g. a client application computer and/or a mobile phone, of the second subscriber, as shown in the figure. The gateways are overlaid with service objects, i.e. they are loaded with software comprising code sequences to perform the steps of the inventive method (data flow object). As an example scenario a distributed trusted content delivery system is shown. According to the inventive method it is determined whether a transaction (content data transmission) is completed correctly and such determination is reported. Preferably, this is done by one of the network nodes of the data transmission path, which is comprising means for carrying out the inventive method. The inventive method is used for determining whether a transaction from a certain first subscriber to a certain second subscriber is completed correctly and for reporting such determination to the first subscriber. Network Access Providers (NAPs) control and monitor the physical path of the content data flow from the network entry gates to the customers access node by inserting data flow objects into the network. Data flow objects are implemented in software (SW) or hardware (HW) or both. They exchange messages with other objects distributed over the network, and may naturally be implemented in object-oriented technologies. At the beginning of a transaction a data flow object is created. This data flow object characterizes the transaction, the first subscriber and the terminal from which the transaction is originated. By means of the data flow object a reliable and trusted path is set up from the first subscriber to the second subscriber. The transaction content is delivered via this path and after successful completion of the transaction such completion is reported.

Data flow objects are located at distinct access nodes, e.g. DSLAM, and are so ensuring an unambiguous relation between the ordering subscriber, its terminal and its physical access link. The same is true for network elements located at the border to the provider and its content server.

In the figure there are shown several data flow objects as symbols. Two of them, named subscriber proxy 12 and salesman proxy 10, are floating objects, which are not bound to a location. A data flow object controlling the access data flow 13 is bound to an access gateway, which is shown as the GW one of the dotted arrows is pointing at in the figure. This current access gateway is an inventive network node. The Terminal Proxy 11 is the representation of the terminal of the second subscriber in the network of the NAP. It contains information about properties of the terminal of the second subscriber ,at least the IP-address of the terminal of the second subscriber. The Terminal Proxy 11 may be used to improve the inventive method by a transcoding, which may be necessary eventually. In the figure there is shown a mobile phone as the terminal of the second subscriber. A mobile phone needs different MPEG-data streams as a computer terminal connected to a DSL-connection, e.g. it needs a different bandwidth, different resolution and/or different usable codec. This can be recognized by another instance in the network and/or by the aid of the terminal proxy by the first subscriber, who can react accordingly.

Data flow objects are instantiated on-demand for each transaction, at least one at the subscriber access node and optionally one for the content server. They set up a reliable and trusted pathway between the involved provider node and the subscriber terminal. Via this path the transaction content is delivered. Instantiation of these data flow objects is secured in that they are created only in context with the creation of a valid transaction relation, and are always linked to the subscriber and the terminal which is placing the order. After successful completion of delivery and reporting of the final state and transaction details the data flow objects are removed.

Data flow objects can also be instantiated once for atonement-like services, which do not have a predefined start and end of usage, e.g. pay television (TV) channels. In this case the data flow object serves as defined and trusted delivery point for an associated terminal.

Data flow objects have the task to take up the identified content, deliver it to the next involved data flow object or finally to the subscribers terminal, and record and compile trusted detailed reports at the end of each transaction, e.g. for the customer and the content provider.

In the example of the inventive method shown in FIG. 2 content data is delivered from a content application server (first subscriber) to a client application (second subscriber). The direction of the data flow is shown as arrows marked with reference numbers in the figure. The delivery is carried out via network nodes of a data transmission network building a transmission path. The transmission network is being controlled by controlling means of a network controller, e.g. a NAP. For example these controlling means are a network node, loaded with a software with code sections to perform the controlling, e.g. a terminal proxy. Firstly, the client application requests for pay-content (content data) 1. A mandate for content data delivery is created. This is done by a standard HTTP request from a client terminal to a WWW server. After that, the application server redirects the mandate to the salesman proxy 2, which is a software loaded on a network node, e.g. a server, of the data transmission network. The salesman proxy is located in the same trusted domain as the subscriber. Now the second subscriber is discovered and contacted 3 and negotiation e.g. about the trusted content delivery and/or payment creditability is started. The transmission path is set up by choosing a second network, having an exclusive data transfer connection to said second subscriber, by said network controlling means. A check for the subscribers profile and a confirmation of the order is performed 4. This profile may include data concerning e.g. payment preferences, e.g. prepaid account or limits, deny lists and an age verification. After that, the salesman proxy requests content data from the application server 5. Now the trusted content data delivery (transmission) via network nodes, building a transmission path, e.g. the access gateway and optional the Content Gateway, through the terminal proxy and the salesman proxies is performed 6. The content data from said first subscriber is received by a first network node of said network nodes of the transmission network and sent from the first network node to the second network node and from the second network node to the second subscriber. The terminal proxy is a software which is loaded on a network node of the transmission path. The content data transmission is done by a hop-by-hop principle. It has a standard HTTP response towards the client terminal. A decision is made, whether the transmission of content data from the first subscriber to the second subscriber is completed correctly depending on a result of a comparison of data content reports. A first data content report, comprising information about said content data is set up by the first network node, and a second data content report, comprising information about said content data, is set up by the second network node. The comparison may be made by the second network node, i.e. a data flow object which is instantiated at the second network node (second data flow object). Depending on the result of the comparison, it is decided whether the transmission of content data from the first subscriber to the second subscriber is completed correctly. Finally the terminal proxy confirms complete delivery 7 of the content data, if so, and a detailed report, for example including billing information is sent to the salesman and the subscriber proxies 8. A trusted delivery of the content data is guaranteed, because the content data passed through the access node of the subscriber.

1. A method for determining whether a transaction comprising a transmission of content data from a first subscriber to a second subscriber via network nodes of a data transmission network building a transmission path, said transmission network being controlled by controlling means of a network controller, is completed correctly, comprising the steps of
receiving said content data from said first subscriber by a first network node of said network nodes,
setting up a first data content report, comprising information about said content data, or receiving said first data content report from said first subscriber, by said first network node,
setting up said transmission path by choosing a second network node of said network nodes, having an exclusive data transfer connection to said second subscriber, by said network controlling means,
sending said content data from said first network node to said second network node,
setting up a second data content report, comprising information about said content data, by said second network node,
sending said content data from said second network node to said second subscriber,
making a comparison by comparing said first data content report to said second data content report, by said network controlling means and
deciding whether said transmission of content data from said first subscriber to said second subscriber is completed correctly depending on a result of said comparison, by said network controlling means.

2. The method according to claim 1, characterised in that a message comprising data characterising the content data to be transmitted is received by said first network node.

3. The method according to claim 1, characterised in that data comprising information characterising said transaction, preferably a transaction code, is sent from said first network node to said second network node or network controller, preferably said controlling means.

4. The method according to claim 1, characterised in that a data flow software object is instantiated by said network controlling means in said first and said second network node, said data flow software object comprising software code sections by which the steps of the method according to claim 1 are carried out.

5. The method according to claim 1, characterised in that said first and/or second data content report is comprising information characterising said transaction, preferably a transaction code received from said network controlling means by said first and/or said second network node.

6. A network node of a path of a data transmission network for carrying out the method for determining whether a transaction comprising a transmission of content data from a first subscriber to a second subscriber via said path is completed correctly according to the method of claim 1, comprising
content data receiving means, being designed to receive said content data,
content reporting means, being designed to set up a first data content report, or to receive a first data content report, comprising information about said content data,
sending means, being designed to send said content data to said second subscriber or to a second network node,
data content report receiving means, being designed to receive a second data content report, comprising information about said content data,
network controlling means, being designed to make a comparison by comparing said first data content report to said second data content report and
to decide whether said transmission of content data from said first subscriber to said second subscriber is completed correctly depending on a result of said comparison.

7. A data transmission network for carrying out the method for determining whether a transaction comprising a transmission of content data from a first subscriber to a second subscriber via network nodes of a data transmission network building a transmission path, said transmission network being controlled by controlling means of a network controller, is completed correctly, according to claim 1, comprising
a first network node of said network nodes, being designed to receive said content data from said first subscriber, and to set up a first data content report, comprising information about said content data, or receiving said first data content report from said first subscriber,
said controlling means being designed to set up said transmission path by choosing a second network node of said network nodes, having an exclusive data transfer connection to said second subscriber,
sending means, being designed to send said content data from said first network node to said second network node,
said second network node, being designed to set up a second data content report, comprising information about said content data and to send said content data from said second network node to said second subscriber, and
said controlling means being designed to make a comparison by comparing said first data content report to said second data content report, and to decide whether said transmission of content data from said first subscriber to said second subscriber is completed correctly depending on a result of said comparison.

8. The data transmission network according to claim 7, characterised in that said first network node is having an exclusive data transfer connection to said first subscriber.

9. A data transmission network for carrying out the method for determining whether a transaction comprising a transmission of content data from a first subscriber to a second subscriber via said path is completed correctly according to the method of claim 1, comprising at least first and second network nodes, with said first network node including
content data receiving means, designed to receive said content data,
content reporting means, designed to set up a data content report, or to receive a data content report, comprising information about said content data, and
sending means, designed to send said content data to said second subscriber or to said second network node.

10. A data transmission network comprising at least one microcomputer loaded with a computer program with software code sections by which the steps of the method according to claim 1 are carried out.
